(19) United States
(12) Patent Application Publication
(10) Pub. No.: US 2007/0023723 A1
(43) Pub. Date: Feb. 1, 2007

(54) Electric valve for controlling the delivery of pressurized fluid

(76) Inventor: Curzio Aldo Magri, Gorle (IT)

Correspondence Address: MODIANO & ASSOCIATI, Via Meravigli, 16, Milan, 20123, IT

(21) Appl. No.: 11/491,393

(22) Filed: Jul. 24, 2006

(30) Foreign Application Priority Data
Jul. 29, 2005 (IT) MI2005A001496

(51) Int. Cl. F16K 31/02

(52) U.S. Cl. 251/129.21

(57) ABSTRACT

An electric valve for controlling the delivery of pressurized fluid, comprising: an electric valve body, forming internally a fluid intake port and a delivery chamber coupled to a discharge duct containing a discharge port, a flow control element, supported by a shuttle arranged transversely with respect to the flow passage direction and movable in the fluid flow direction. The shuttle is end supported by a guiding element, engaged with the shuttle and separated from it by a pair of lateral membranes, the flow control element is movable from an open position, to allow connection of the intake port to the discharge port, to a closed position, for interrupting connection between the intake port and the discharge port.

The present invention relates to an electric valve for controlling the delivery of pressurized fluid. More particularly, the invention relates to an in-line electric valve with complete separation, for controlling the delivery of pressurized fluid.

### BACKGROUND OF THE INVENTION

As is known, conventional electric valves for controlling the delivery of pressurized fluid have a longitudinal, i.e., in-line, internal fluid passage, in which the fluid necessarily comes into contact with the metallic parts of the electric valve; accordingly, such electric valves suffer problems linked to contamination of the fluid, jamming due to the action of impurities in the fluid and of scale, noise due to scale between the polar magnetic surfaces, and therefore known types of electric valve do not have optimum reliability and durability.

### SUMMARY OF THE INVENTION

The aim of the present invention is to provide an electric valve for controlling the delivery of pressurized fluid that allows to maintain total separation between the fluid that flows through the body of the electric valve and the metallic parts that drive the closure and opening of the electric valve.

Within this aim, an object of the present invention is to provide an electric valve for controlling the delivery of pressurized fluid in which the flow control element arranged in the delivery chamber of the valve is isolated by means of a pair of membranes.

Another object of the present invention is to provide an electric valve for controlling the delivery of pressurized fluid that is highly reliable, relatively simple to provide and at competitive costs.

This aim and these and other objects, which will become better apparent hereinafter, are achieved by an electric valve for controlling the delivery of pressurized fluid, characterized in that it comprises:

an electric valve body, which forms internally a fluid intake port and a delivery chamber which is rigidly coupled to a discharge duct which contains a discharge port;

a flow control element, which is supported by a shuttle arranged transversely with respect to the flow passage direction, the flow control element being movable in the fluid flow direction;

said shuttle being supported at the end by a guiding element, which is engaged with said shuttle and is separated therefrom by a pair of lateral membranes;

said flow control element being movable from an open position, in which it allows the connection of said intake port to said discharge port, to a closed position, in which the connection between said intake port and said discharge port is interrupted.

### BRIEF DESCRIPTION OF THE DRAWINGS

Further characteristics and advantages of the invention will become better apparent from the description of a preferred but not exclusive embodiment of the electric valve according to the present invention, illustrated by way of non-limiting example in the accompanying drawings, wherein:

FIG. 1 is a longitudinal sectional view of the electric valve according to the present invention, in the open condition;

FIG. 2 is a view, similar to FIG. 1, of the electric valve according to the invention in the closed condition.

### DESCRIPTION OF THE PREFERRED EMBODIMENTS

With reference to the figures, the electric valve according to the present invention, generally designated by the reference numeral 100, comprises an electric valve body 1, inside which, at opposite ends thereof, an intake port A and a discharge port C are provided, respectively to allow the inflow and outflow of a pressurized fluid.

The electric valve is provided with a flow control element 3, which is supported conveniently by an element 2 for supporting the flow control element, hereinafter referenced as flow control element supporting shuttle, which is arranged transversely with respect to the directions D in which the fluid flows within the body 1 of the valve.

Two lateral membranes 4 are arranged respectively laterally to the supporting element or shuttle 2 and are locked by retention elements 5 arranged respectively at the right and left lateral membranes.

The shuttle 2 is engaged in a shuttle guiding element 6, which is rigidly coupled, by means of a spring supporting element or spring holder 9, to a magnetic moving core 11, which is arranged along the discharge duct 21 of the valve body.

The upper spring holder 9 supports an upper spring 10, while a lower elastic element, constituted for example by a leaf spring 8, is arranged below the shuttle guiding element 6.

The electric valve further has a spool 13, a fixed core 12 arranged coaxially to the discharge duct 21, and a magnetic armature 15, which accommodates a coil 16.

An enclosure or container element 19 encloses all the parts of the electric valve on the valve body 1, with the interposition of at least one sealing O-ring 7.

Moreover, the electric valve is completed by the presence of an electronic part with contacts, designated schematically by the reference numeral 20.

With reference to the figures, operation of the electric valve according to the present invention is as follows.

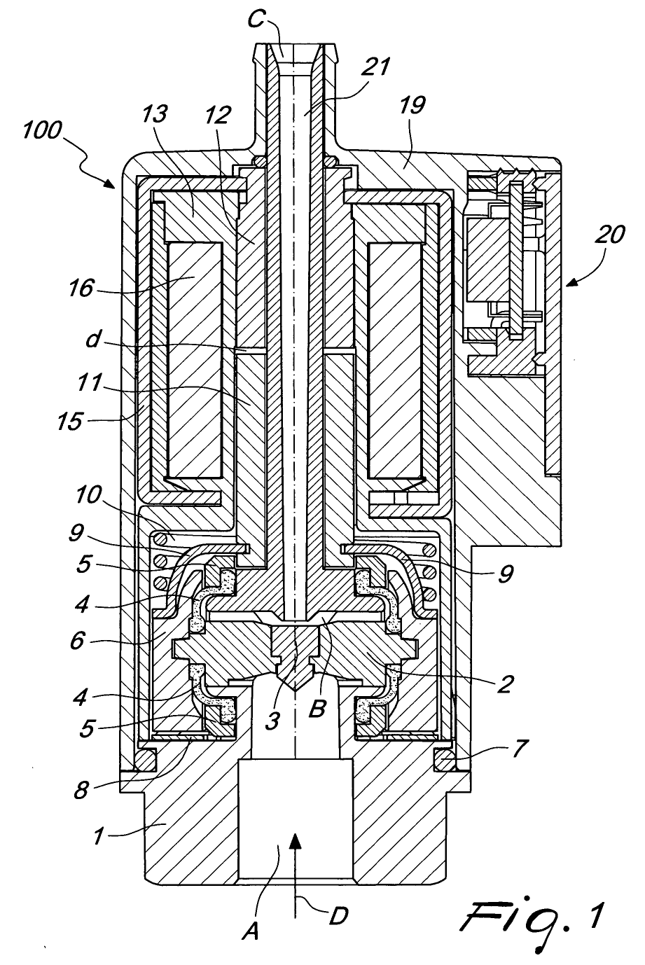

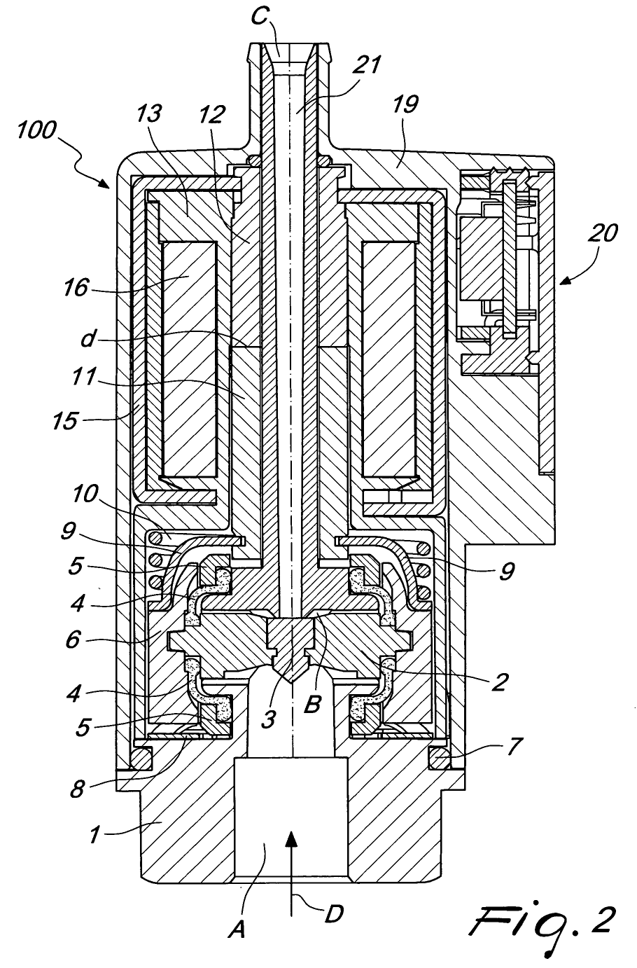

The electric valve has two states: the first one, shown in FIG. 1, in which the electric valve is in the open condition, and the second one, shown in FIG. 2, in which the electric valve is in the closed condition.

In the first state, the coil 16 of the electric valve is not powered, while in the second state it is. In the de-energized state, the electric valve is normally open.

In the inactive state, i.e., when the coil 16 is not powered, the moving core 11 is rigidly coupled to the upper spring holder 9 and the upper spring 10 acts on the spring holder 9, which pushes the guiding element 6, rigidly coupled to the shuttle 2 for supporting the flow control element 3, into the inactive position, overcoming the force of the lower spring 8 (leaf spring) and the force of the corresponding separation membranes 4, which are kept in their position by the retention elements 5.

Accordingly, the fluid flows from the intake port A of the body 1 of the valve and enters the duct of the delivery chamber, designated by the reference letter B, by passing through the shuttle 2 and flowing out toward the discharge C, again through the duct B of the delivery chamber.

In the energized state, the coil 16, due to the magnetic field generated by the flow of current across the winding 16 and concentrated in the fixed core 12, said fixed core 12 attracts the moving core 11, which performs a stroke indicated by the reference letter “d”, overcoming the force of the upper spring 10, which performs the same movement stroke “d”, allowing the shuttle 2, pushed by the lower spring 8, to close the duct B of the delivery chamber, as shown in FIG. 2.

Accordingly, the fluid flows through the body in a longitudinal direction without said fluid coming into contact with the metallic parts that drive closure and opening, said parts being actuated by the electromagnet, the fluid flowing in line with respect to the magnetic means for actuating the valve.

In practice it has been found that the electric valve according to the invention achieves the intended aim and objects, since it allows to keep the fluid away from contact with the metallic actuation parts of the electric valve; moreover, the shuttle for supporting the flow control element is arranged in the delivery chamber B at right angles or transversely to the direction of advancement of the fluid, isolated externally by means of the flexible membranes 4, which allow its movement.

Furthermore, the delivery chamber B is formed monolithically or in a sole body and the intake passage A and discharge passage C for the fluid are formed therein.

The electric valve thus conceived is susceptible of numerous modifications and variations, all of which are within the scope of the appended claims; all the details may further be replaced with other technically equivalent elements.

Terms such as “upper” or “lower” used herein, are intended to refer for the mere purposes of description to the valve as shown in the figures. Therefore, they are not intended as imposing positional limitations onto the elements to which they refer.

In practice, the materials used, as well as the contingent shapes and dimensions, may be any according to requirements and to the state of the art.

The disclosures in Italian Patent Application No. MI2005A001496 from which this application claims priority are incorporated herein by reference.

What is claimed is:

1. An electric valve for controlling the delivery of pressurized fluid, comprising:
an electric valve body, having internally a fluid intake port and a delivery chamber coupled to a discharge duct, said discharge port being located at an end of said discharge duct;
a shuttle arranged transversely with respect to a flow direction;
a flow control element, supported by said shuttle, the flow control element being movable in the fluid flow direction;
a pair of membranes mounted lateral to said shuttle;
a guiding element, which supports at an end thereof said shuttle, is engaged therewith and is separated therefrom by said pair of lateral membranes; and wherein
said flow control element is movable between an open position, for allowing connection of said intake port to said discharge port, and a closed position, for interrupting the connection between said intake port and said discharge port.

2. The electric valve of claim 1, wherein said delivery chamber forms a sole body.

3. The electric valve according to claim 1, comprising:
a moving core arranged along the discharge duct of the electric valve; an upper spring; and
a spring holder supported by said guiding element and which is rigidly coupled to said spring holder supporting said upper spring.

4. The electric valve of claim 3, further, comprising a lower spring arranged below said guiding element engaged with said shuttle.

5. The electric valve of claim 3, further comprising a fixed core, which is arranged coaxially to said discharge duct and is spaced from said moving core when said flow control element is in the open position.

6. The electric valve of claim 3, comprising retention elements provided so as to keep in position said membranes arranged laterally to said shuttle for supporting the flow control element.

7. The electric valve of claim 3, comprising a spool with a coil which is adapted to be crossed by current.

8. The electric valve of claim 1, comprising a container element adapted to be coupled in an upward region to said electric valve body.
